(19) United States
(12) Patent Application Publication
(10) Pub. No.: US 2007/0029340 A1
(43) Pub. Date: Feb. 8, 2007

(54) Dispenser system and apparatus for recorded media

(75) Inventors: Keith C. Nagelski, Huntersville, NC (US); Ronald M. Marsilio, Lake Wiley, SC (US); Mitchell S. Goldstein, Rock Hill, SC (US)

Correspondence Address: SAND & SEBOLT, AEGIS TOWER, SUITE 1100, 4940 MUNSON STREET, NW, CANTON, OH, 44718-3615, US

(73) Assignee: ALPHA SECURITY PRODUCTS, INC., Charlotte, NC (US)

(21) Appl. No.: 11/377,051

(22) Filed: Mar. 16, 2006

Related U.S. Application Data
(60) Provisional application No. 60/705,037, filed on Aug. 3, 2005.

(51) Int. Cl. B65G 59/06

(52) U.S. Cl. 221/268

(57) ABSTRACT

A dispenser for individually dispensing items of merchandise, such as recorded media contained in rectangular-shaped boxes, from a plurality of vertically stacked media secured in a locked housing supported on a display fixture. A pivotally mounted security door closes and exposes an open front of the housing having an internal storage compartment for the stacked media. The door includes a magnetically actuated lock mechanism. A slide mechanism contained in a tray mounted beneath the housing has a tab which engages the rear of the bottommost media and ejects it through a lower discharge opening in the housing when actuated by a control button projecting from the front of the housing. A pivotally mounted transparent display panel is mounted on the front of the housing and contains one of the recorded media for viewing both sides thereof by a potential customer.

### CROSS REFERENCE TO RELATED APPLICATIONS

This application claims priority from U.S. Provisional Application Ser. No. 60/705,037 filed Aug. 3, 2005; the disclosure of which is incorporated herein by reference.

### BACKGROUND OF THE INVENTION

1. Technical Field

The invention relates to dispensing systems and in particular to a dispenser for dispensing items of merchandise one at a time with a time delay between the individual dispensing of the items to prevent rapid removal of a plurality of the items from the dispenser by a potential shoplifter. Even more particularly, the invention relates to such a dispensing device for dispensing recorded media such as DVDs, VHS tapes, video games etc. for purchase by a perspective purchaser, which includes a display panel for displaying both sides of the recorded media to the customer and which secures a number of the recorded media in a locked compartment.

2. Background Information

It is desirable in retail establishments such as large volume discount stores, electronic stores, video game stores, movie rental and sales stores etc. to display the items for purchase in racks and bins in order to provide a sufficient supply of the item for the customer and to avoid constant restocking of the items throughout a business day. However, this presents a problem for certain items of merchandise which are subject to shoplifting wherein an individual can rapidly remove a number of the items from the display rack or storage container and place the same in a concealed location or run from the store without paying the selected items.

It is also desirable for certain items such as recorded media, to permit the customer to remove one of the items from a secure environment for take out to the checkout counter without exposing the remaining items to theft, and in which the contents of the recorded media stored in the protected container is easily viewed by a customer. Various devices have been devised to prevent loss of merchandise such as the placement of EAS tags on the items or securing the items in a locked cabinet or dispenser, all of which increases the cost of doing business and delay in checking the customer out at a checkout station. Also, this inconveniences the customer, possibly resulting in loss of good will and even the customer to a competitor store if a clerk is required to unlock a cabinet even for the customer to review the contents of the stored item and any advertisements associated therewith. It is desirable that a perspective customer be able to view the contents of the item when in a stored position in the dispenser and to read the information printed on the storage boxes or containers prior to removing the same from their stored position for purchase. Also, it is desirable to enable the customer to replace a dispensed item into the dispenser should he/she change his or her mind after reviewing the dispensed item.

Thus, the need exists for an improved dispenser and system of dispensing various items of merchandise such as recorded media, which prevents a customer from removing a plurality of the items from a protected display container or housing in rapid concession, but permitting individual items to be dispensed one at a time from the storage housing for subsequent purchase by the customer at a checkout counter.

### BRIEF SUMMARY OF THE INVENTION

One feature of the invention is to provide a dispenser and dispensing system for various items of merchandise such as recorded media, which usually consists of a generally flat rectangular parallelpiped shaped box in which the items are stored in a secured compartment preventing the rapid removal of a plurality of the recorded media therefrom, but which enables individual recorded media to be removed from the secured container by a perspective customer.

Another aspect of the invention is to provide a dispenser having a display panel associated with the protected housing with a sample recorded package or display box mounted therein to enable a customer to view both sides of the recorded media to determine if he/she wishes to purchase the same in an easy and convenient manner.

A further feature of the invention is to provide such a dispenser in which the storage housing is protected by a locked security door which can be opened only with a special key such as a magnetic key, which when opened, exposes the entire storage compartment of the housing to enable a plurality of the recorded media to be placed easily therein to replenish items previously removed therefrom.

Another aspect of the invention is to enable the customer to easily return a dispensed item back into the secured housing without requiring a clerk to open the security door by sliding the box through a top opening where it will then return to a vertically stacked array of the recorded media for subsequent purchasing by a customer.

A further feature of the invention is to provide such a dispenser having a mechanism such as a mechanical clicker, which is actuated upon dispensing of an item from the housing to alert a clerk should a number of items be rapidly removed from the housing indicating that a possible theft may be occurring in order to discourage theft and to catch a potential shoplifter.

A still further feature of the invention is to provide such a dispenser in which the individual recorded media is dispensed easily from the secured housing by pressing an exposed button extending outwardly from the front of the housing which automatically ejects a recorded media from the housing after which the ejection mechanism automatically returns to a start position for ejecting another recorded media from the housing when the button is subsequently depressed by a customer.

These features are obtained by the dispensing system of the present invention, the general nature of which may be stated as including a dispensing system for individually dispensing a plurality of recorded media from a plurality of the media in a vertically stacked relationship protected in a locked display housing, said system comprising a housing adapted to be supported on a support member; a security door pivotally mounted at an open front of the housing and movable between an open position and a closed locked position; a slide mechanism protected within the housing and engaged with a bottommost recorded media of said vertically stacked media, said mechanism including a control button extending from the housing for actuating the slide mechanism to push said bottommost recorded media out of the housing through a discharge opening located at a bottom of the security door; a lock mechanism for unlocking and locking the security door; and a display panel pivotally mounted on the housing and covering the security door when in a closed position across the front of the housing.

### BRIEF DESCRIPTION OF THE SEVERAL VIEWS OF THE DRAWINGS

A preferred embodiment of the invention, illustrative of the best mode in which Applicant contemplates applying the principles, is set forth in the following description and is shown in the drawings and is particularly and distinctly pointed out and set forth in the appended claims.

FIG. 1 is a front perspective view of the recorded media dispenser of the present invention mounted on a supporting wall.

FIG. 2 is a perspective view similar to FIG. 1 with the front display panel pivoted to an outward position exposing the security door of the dispenser.

FIG. 3 is an exploded perspective view of the dispenser housing and slide mechanism and supporting tray removed therefrom.

FIG. 4 is a top perspective of the slide tray and slide mechanism in an at rest position.

FIG. 5 is a top plan view of FIG. 4.

FIG. 6 is a fragmentary view with portions in section showing the lower portion of the housing and slide tray and mechanism in an at rest position.

FIG. 7 is a top plan view of the slide mechanism similar to FIG. 5 showing the actuation button being depressed and the slide mechanism in a recorded media dispense position.

FIG. 8 is a front perspective view of the dispenser mechanism with a recorded media being dispensed therefrom by the slide mechanism when in the position of FIG. 7.

FIG. 9 is a fragmentary view similar to FIG. 6 showing the slide mechanism in the eject position as shown in FIG. 8.

FIG. 10 is a view similar to FIG. 9 showing the position of the slide eject mechanism after the recorded media has been removed by a customer.

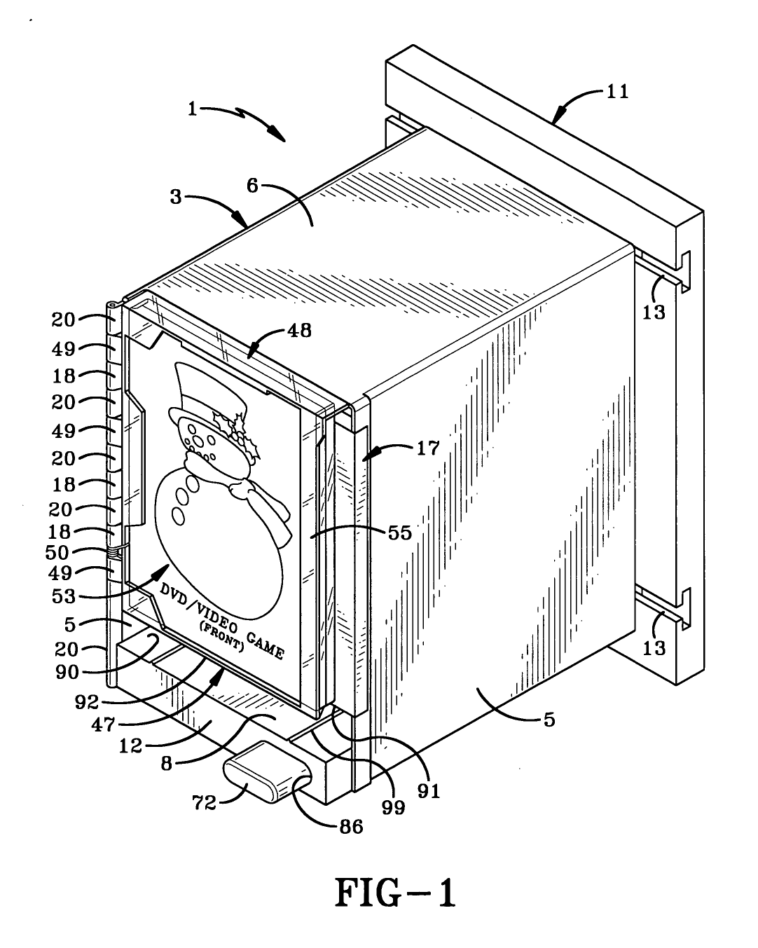

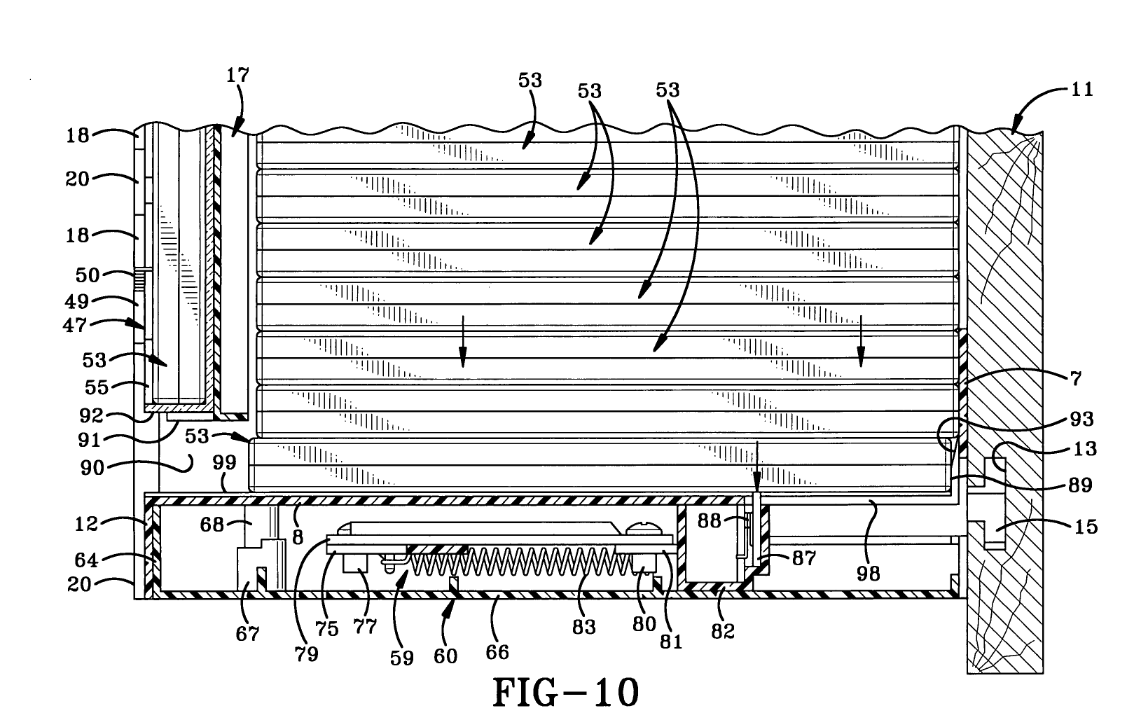

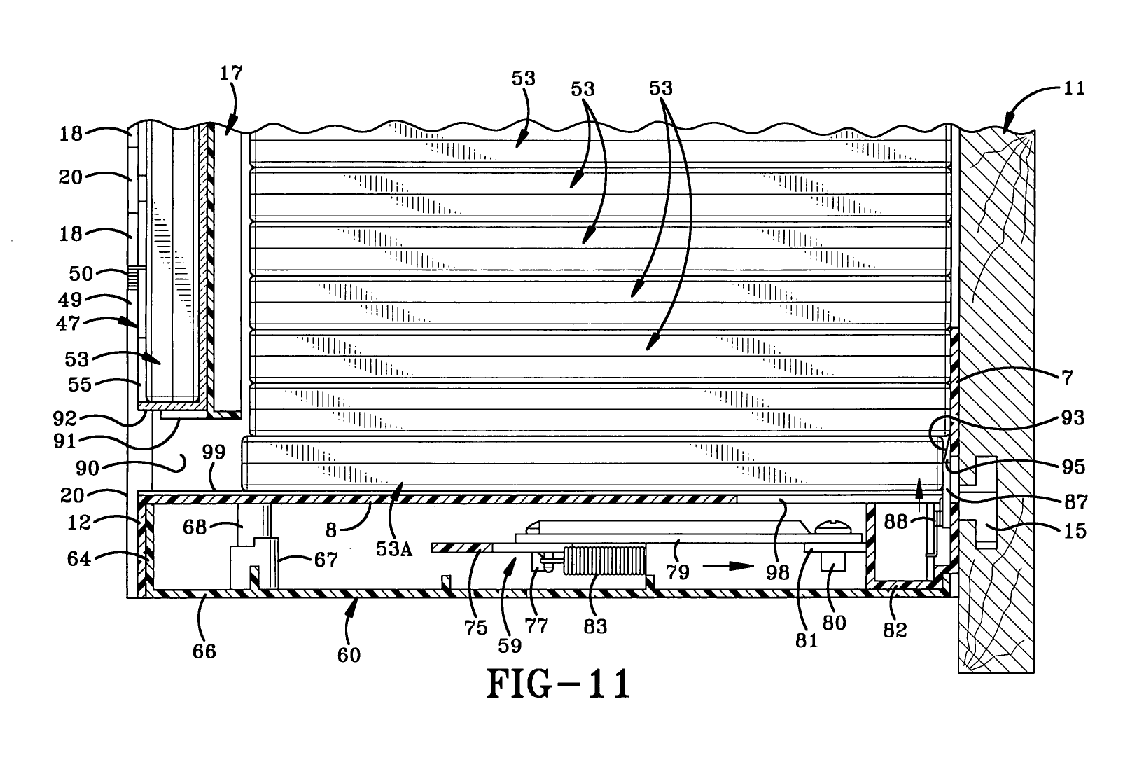

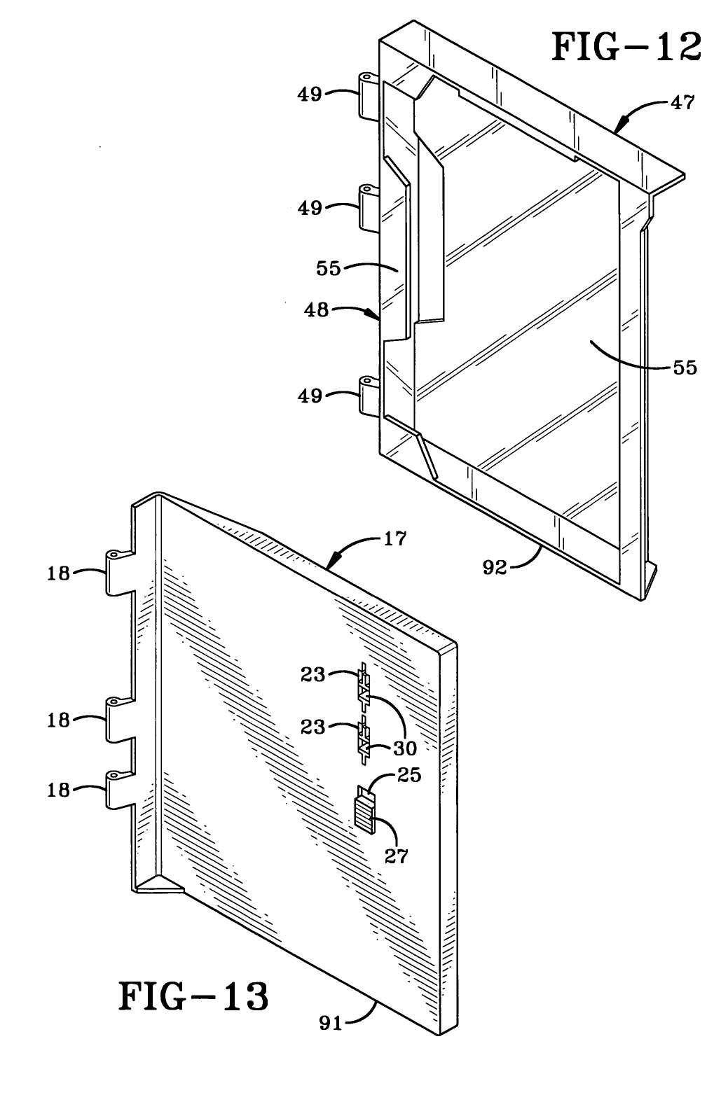

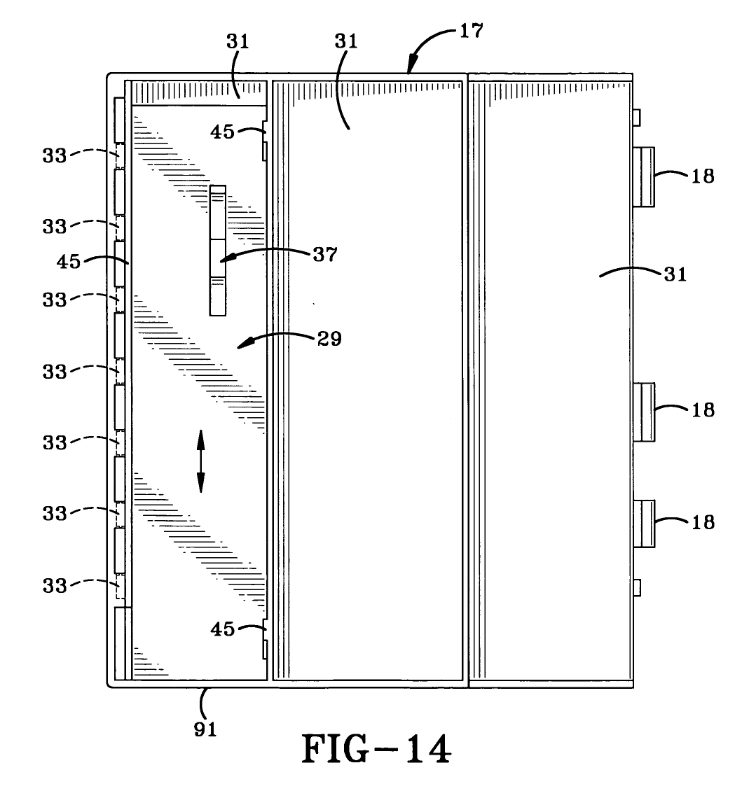

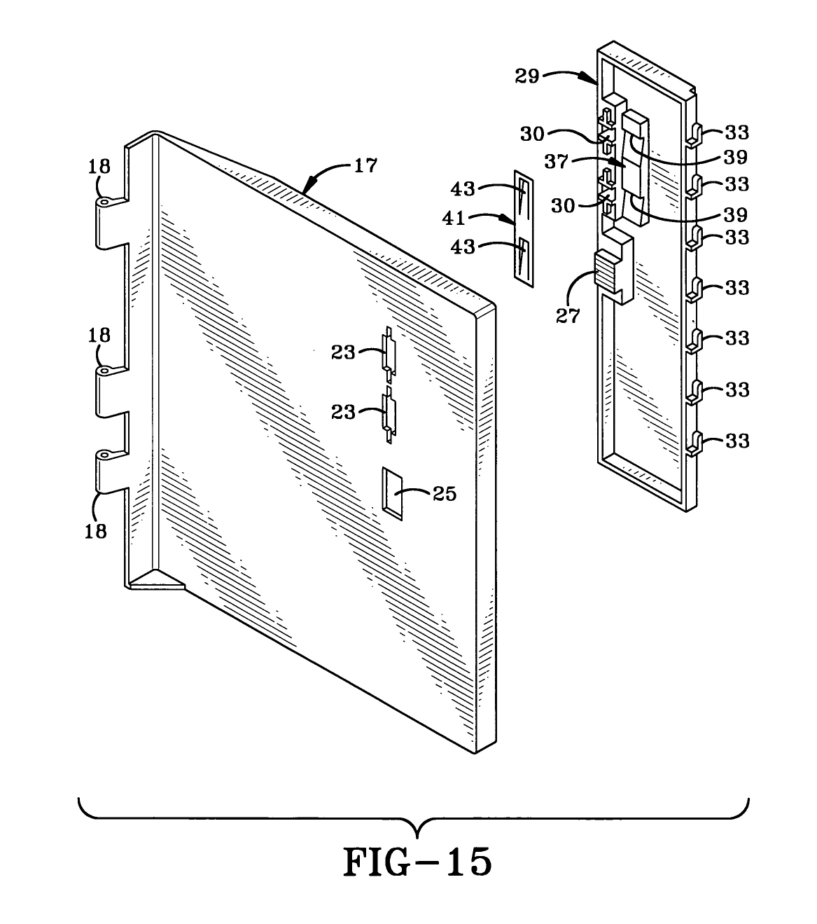

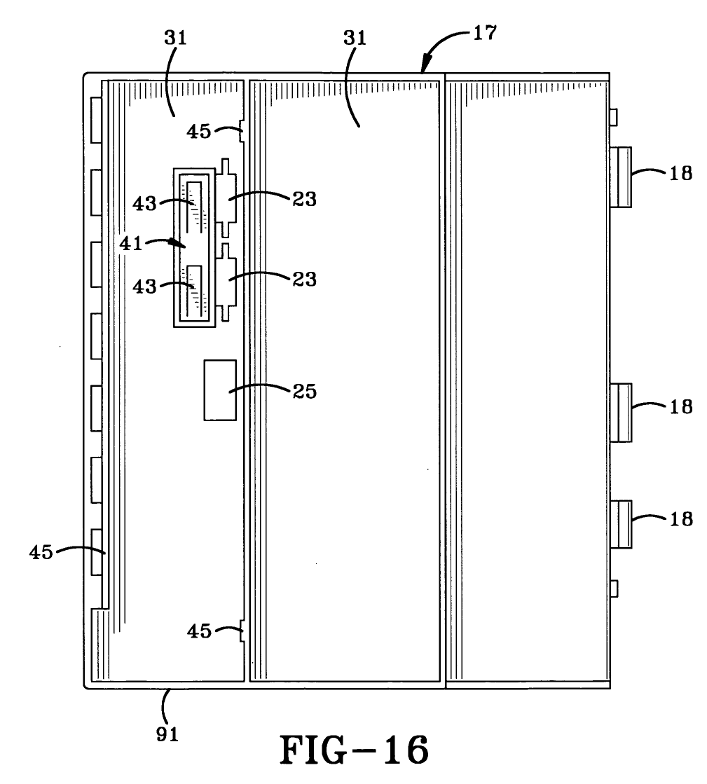

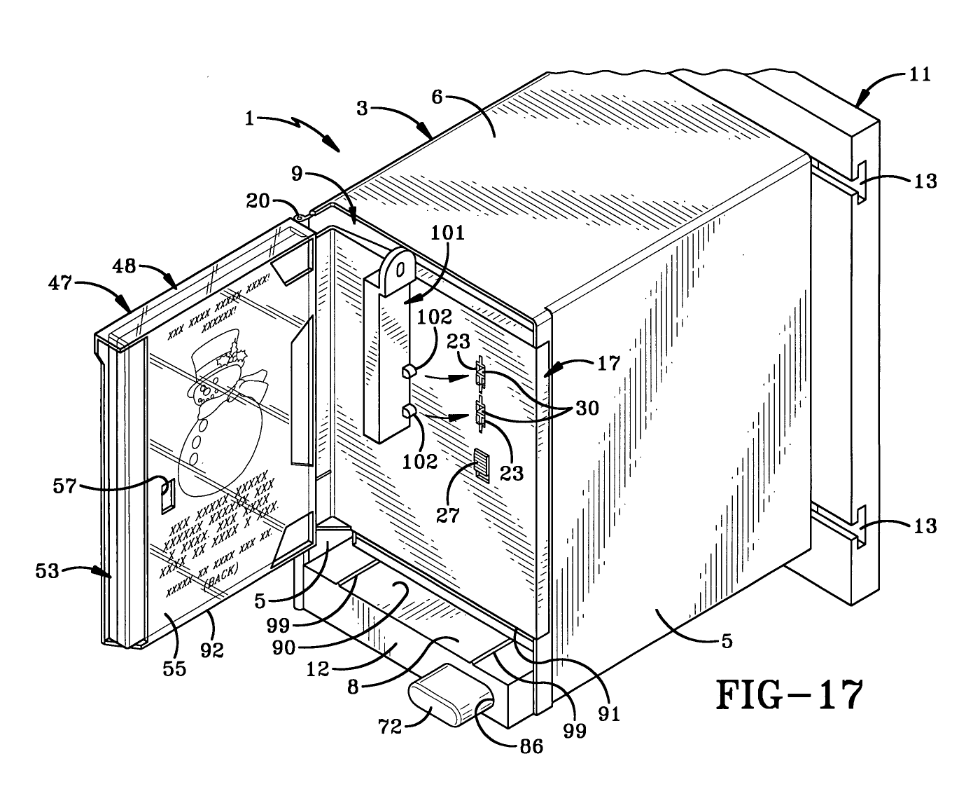

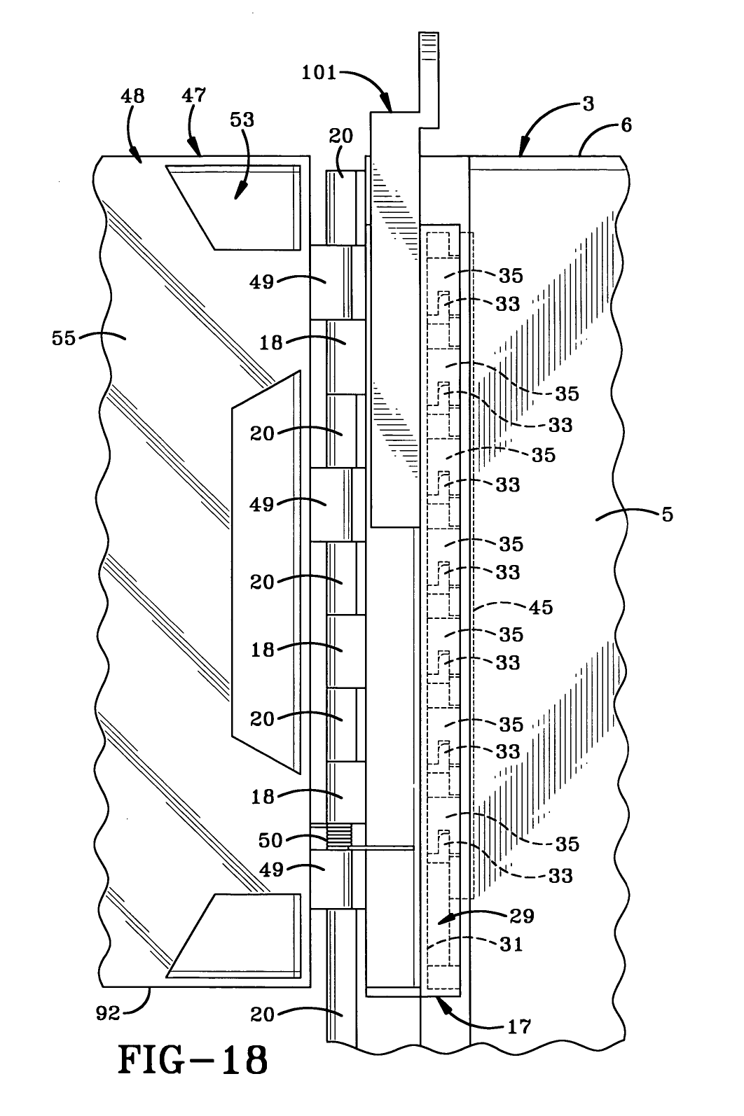

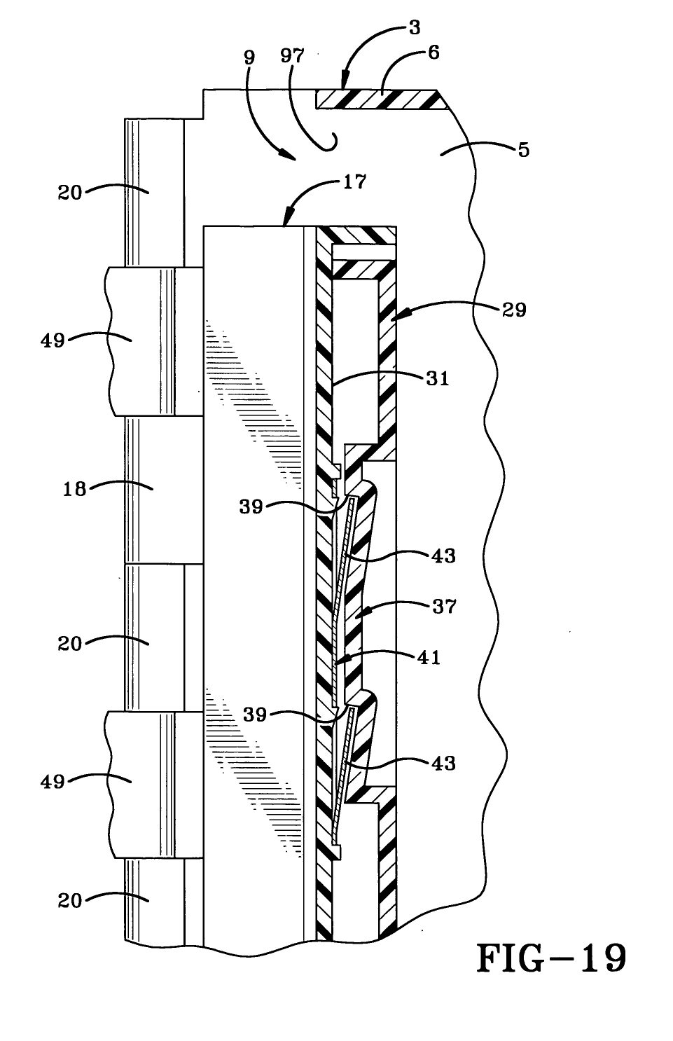

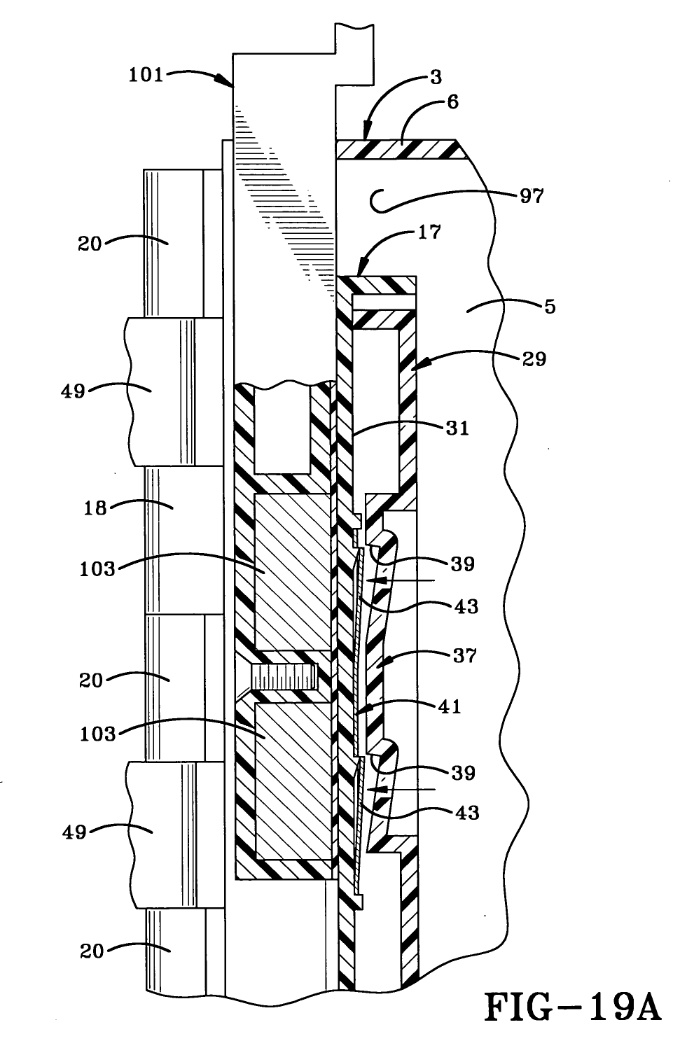

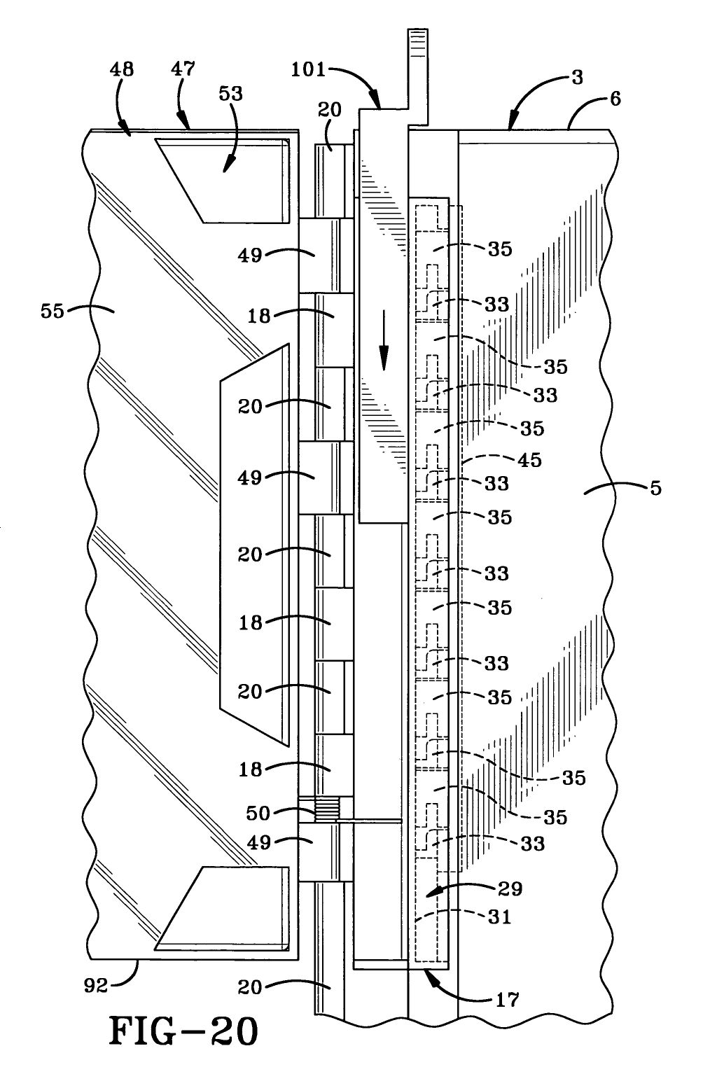

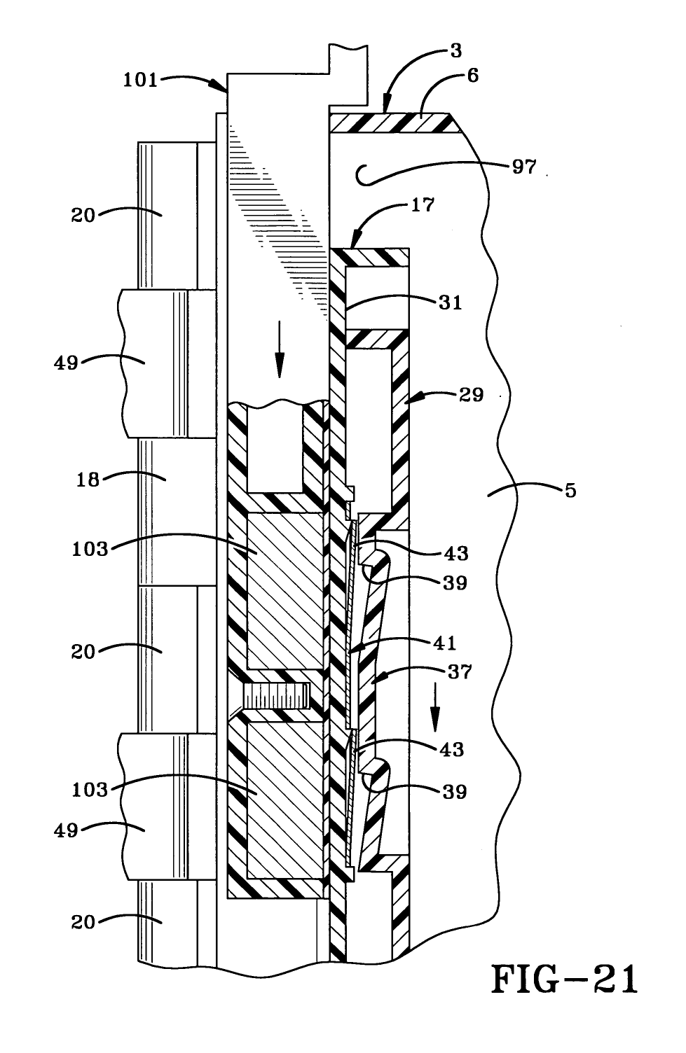

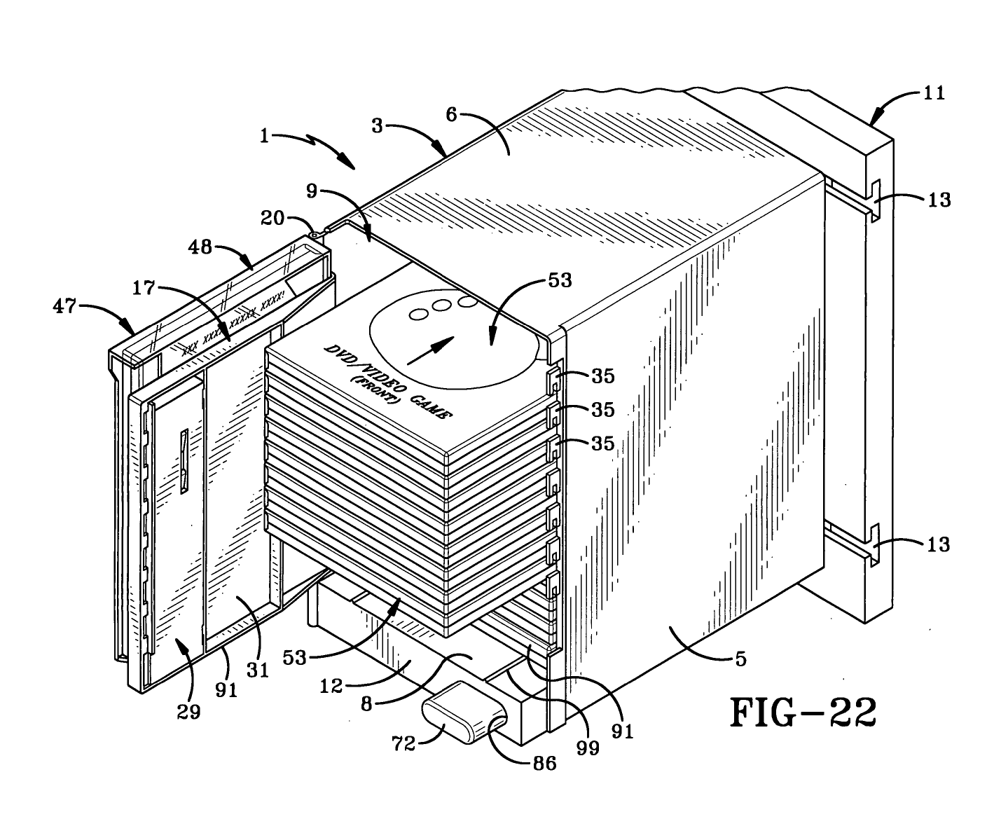

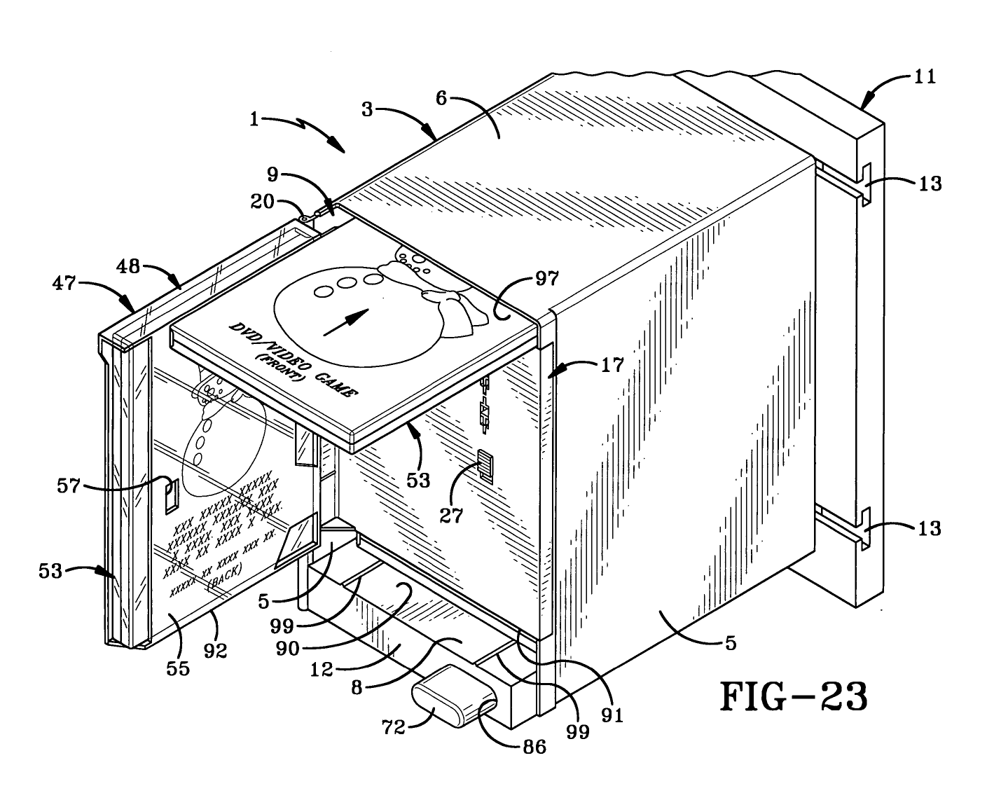

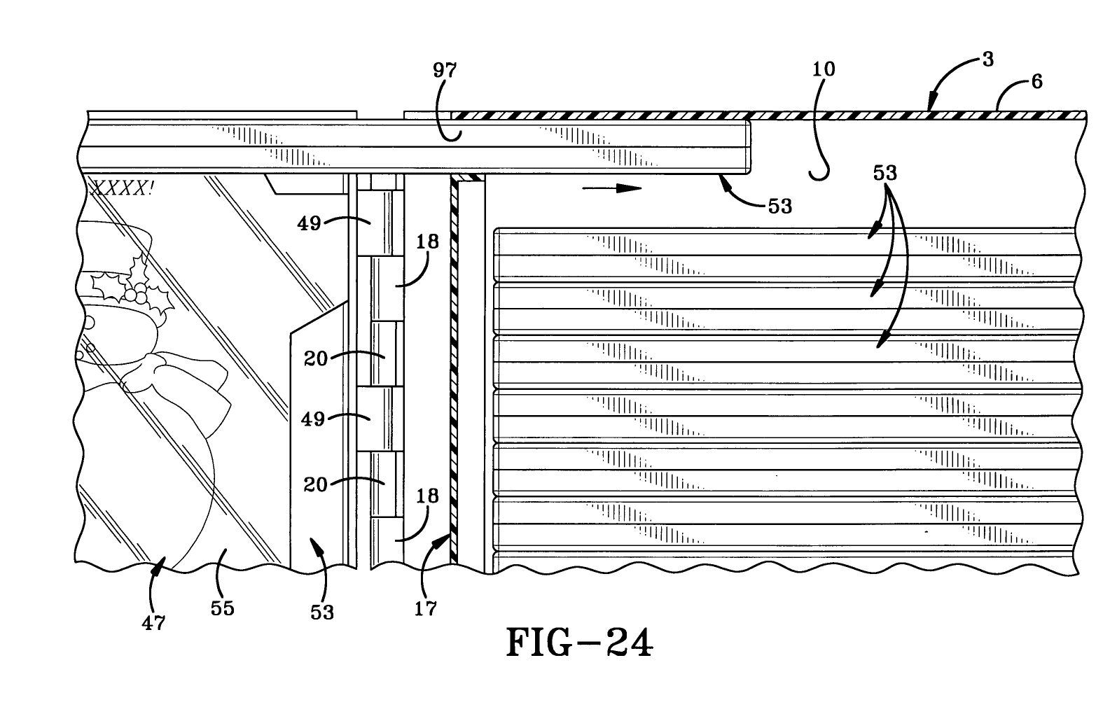

FIG. 1 1 is a view similar to FIG. 10 showing the slide mechanism returned to its at rest position and engaged with the lowermost recorded media for subsequent dispensing.

FIG. 12 is a front perspective view of the display panel removed from the housing.

FIG. 13 is a front perspective view of the security door removed from the housing.

FIG. 14 is a rear elevational view of the security door of FIG. 13.

FIG. 15 is a front perspective view of the security door with the slide lock plate and magnetic locking mechanism exploded therefrom.

FIG. 16 is a rear elevational view of the security door similar to FIG. 14 with the slide lock plate removed therefrom.

FIG. 17 is a front perspective view of the dispenser with the display panel in an outward pivotal location with an unlocking key ready for engagement with the lock door of the housing.

FIG. 18 is a fragmentary view of the security door locking mechanism in locked position with the magnetic unlocking key engaged therewith.

FIG. 19 is an enlarged fragmentary sectional view of the slide lock plate and locking mechanism in locked position.

FIG. 19A is a view similar to FIG. 19 with the two locking tangs of the locking mechanism being moved from the locked position of FIG. 19 to the unlocked position.

FIG. 20 is a view similar to FIG. 18 showing the locking fingers of the lock plate and housing in the unlocked position.

FIG. 21 is an enlarged fragmentary sectional view similar to FIGS. 19 and 19A showing the unlocking key and slide plate being moved toward the unlocked position.

FIG. 22 is a front perspective view of the dispenser with the security door in the open unlocked position and a plurality of recorded media being placed within the storage chamber.

FIG. 23 is a front perspective view similar to FIG. 22 with the security door in locked position showing a single recorded media being placed into the storage chamber through an upper access opening.

FIG. 24 is a fragmentary view with portions in section showing the recorded media being placed into the storage compartment through the upper access opening as shown in FIG. 23.

Similar numbers refer to similar parts throughout the specification.

### DETAILED DESCRIPTION OF THE INVENTION

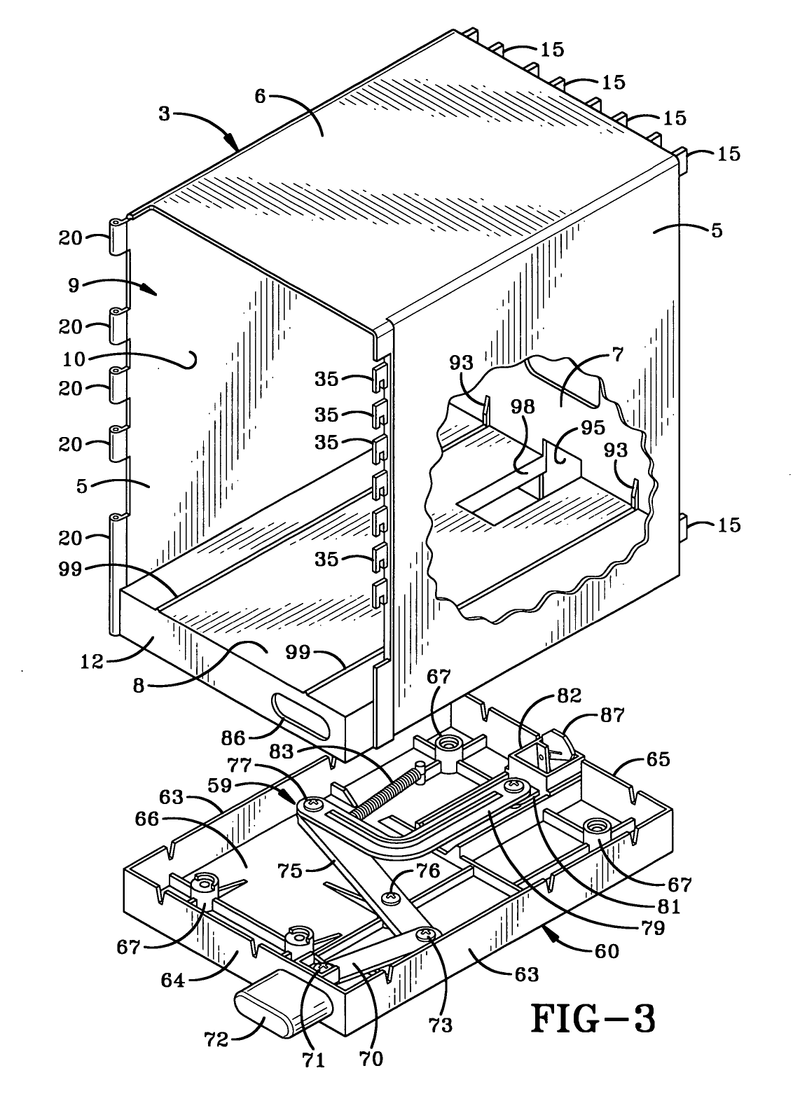

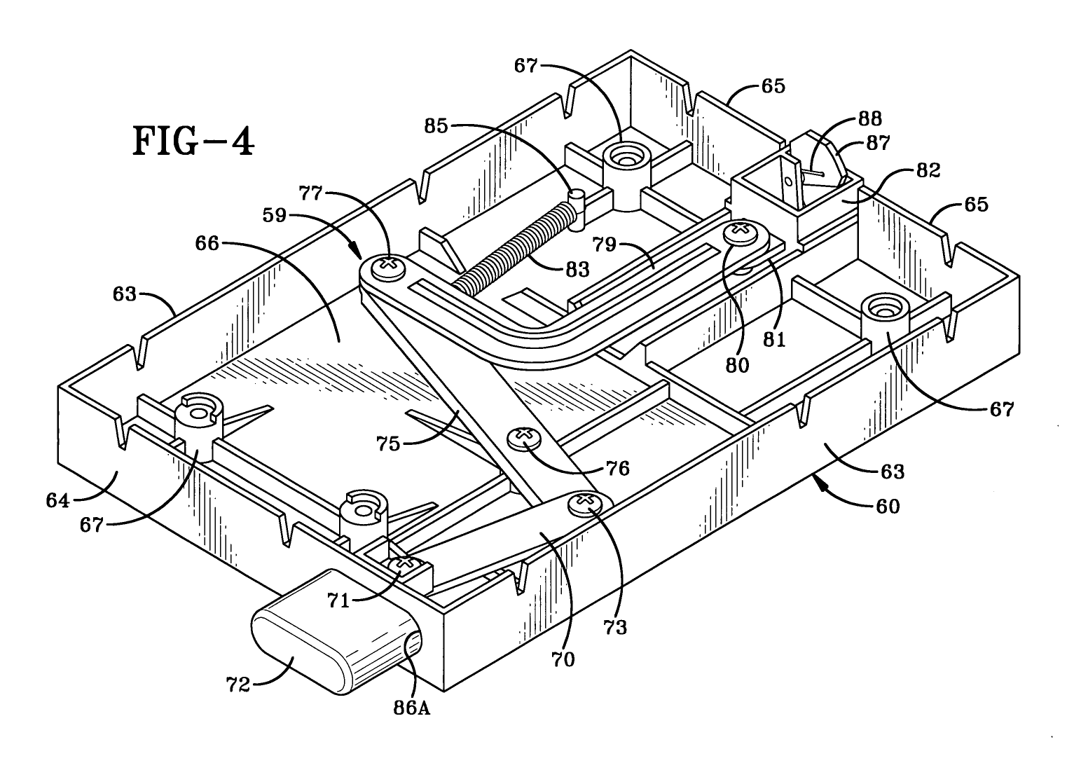

The dispensing system and apparatus of the present invention is indicated generally at 1, and is shown particularly in FIG. 1. Dispensing apparatus 1 includes a security housing indicated generally at 3, which includes spaced side walls 5, a top wall 6, a back wall 7, a bottom wall 8 and a lower front wall portion 12. Housing 3 is formed with an open front 9 (FIG. 3) which provides unlimited access into an interior storage compartment 10 formed in housing 3. Housing 3 is adapted to be mounted on a supporting structure such as a grooved panel 11, which can be provided with a pair of spaced channels 13 into which complementary shaped hooks 15 (FIG. 11) formed on and extending outwardly from back wall 7, can be inserted to mount housing 3 thereon. However, other types of supporting structure than that of panel 11 can be provided without affecting the concept of the invention. If desired, housing 3 could be secured to a horizontal surface and even be freestanding without any attachments without affecting the concept of the invention.

A security door indicated generally at 17 (FIG. 13) is pivotally mounted by a plurality of hinge members collectively indicated at 18, to complementary-shaped hinge members, collectively indicated at 20 (FIG. 3) extending along one edge of front opening 9 of housing 3. Referring to FIG. 13, security door 17 includes a pair of spaced key positioning openings 23 formed therethrough, and a rectangular-shaped opening 25 through which a locking button 27 extends when a slide lock plate indicated generally at 29 is secured to the rear surface 31 (FIG. 16) of door 17. Slide lock plate 29 (FIG. 15) is a rectangular-shaped member formed with a pair of openings 30 which align with openings 23 and has a series of locking teeth or fingers 33 extending along and projecting outwardly from one edge thereof which engage complementary-shaped locking fingers or teeth 35 formed along the opposite edge of housing 3 from hinge members 20 as shown in FIG. 3. Lock plate 29 (FIG. 15) includes a lock projection 37 formed with a pair of right-angled lock surfaces or projections 39 which align with a magnetically attractable locking member 41 which includes a pair of spring biased locking tines 43. Locking member 41 is trapped between projection 37 and the rear surface 31 of security door 17 with actuation button 27 projecting through opening 25 when slide lock plate 29 is mounted on the rear surface of door 17 as shown in FIGS. 13 and 14. Lock plate 29 is retained on the rear surface of security door 17 by a plurality of tabs 45 (FIG. 14) which retain lock plate 29 thereon while permitting limited sliding movement thereof between a locked position as shown in FIG. 18 and an unlocked position as shown in FIG. 20, in which positions locking fingers 33 engage and disengage locking fingers 35 formed on housing 3.

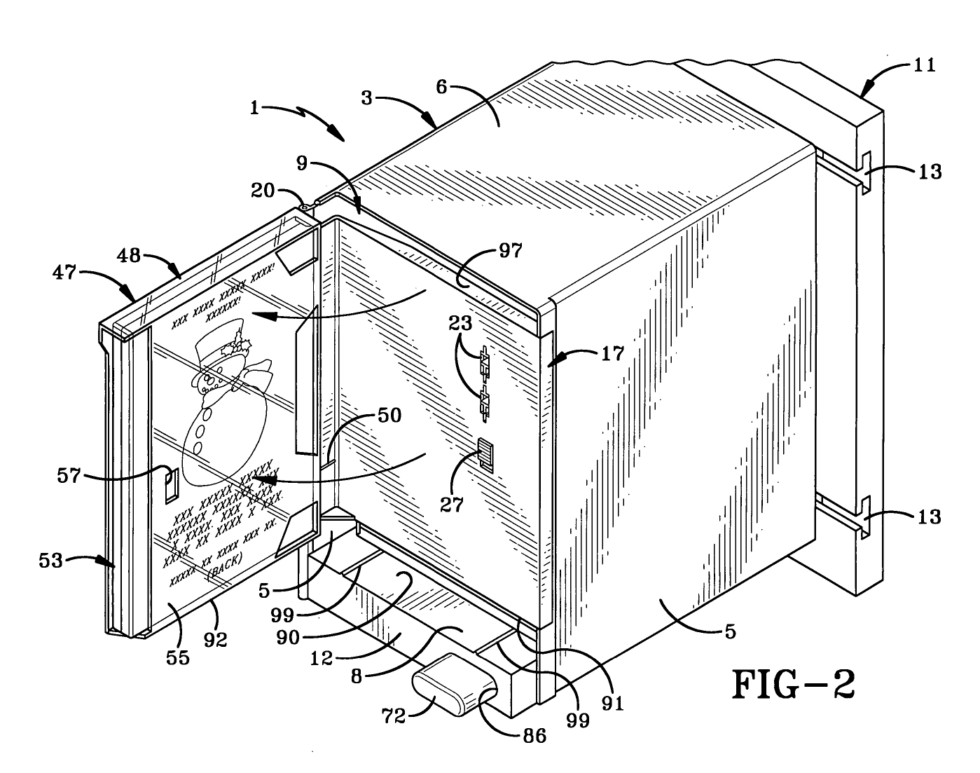

In accordance with another feature of the invention, a display panel indicated generally at 47, is pivotally mounted on the front of housing 3 as shown particularly in FIGS. 1 and 2, and is movable between the closed position of FIG. 1 to the open position of FIG. 2. Display panel 47 is best shown in FIG. 12 and includes a rectangular-shaped frame 48 having a plurality of hinge members 49 formed along one edge thereof for hingedly engaging respective ones of hinge members 20 formed along the front edge of housing 3 as shown in FIGS. 1, 3 and 18. Display panel 47 is adapted to receive a recorded media 53 which is generally a rectangular-shaped box having a parallelpiped configuration with illustrations and printed indicia on the front and rear surfaces thereof, which describe the contents of the recorded media contained therein such as a DVD, video game, VHS etc. The term “recorded media” refers to the display or storage box which contains the actual disc, tape, cartridge etc. on which information is recorded, or to the actual recorded media itself, or to the combination thereof. Panel 47 is biased by a coil spring 50 toward the closed position as shown in FIG. 1 and is freely moveable between the closed position of FIG. 1 and the open position of FIG. 2 by a customer.

Display panel 47 preferably has front and rear panels 55, one or both of which preferably are formed of a transparent material such as plastic which protects the actual recorded media or media package retained therein, yet enables a customer to view both the front and rear of the recorded media by pivotally moving display panel 47 between the positions as shown in FIGS. 1 and 2. The recorded media 53 is retained inbetween the spaced sheets of transparent material 55 by various snap connections, adhesives or the like since the enclosed recorded media may not need contain the actual DVD, VHS etc., and thus need not be protected to any large extent against theft. The rear transparent sheet 55 (FIG. 2) preferably is formed with a rectangular opening 57 through which slide lock plate button 27 extends when panel 47 is in a closed position. If desired, panel 47 can be a rectangular frame with both sides open for viewing the printed indicia on the recorded media without transparent sheets covering the open sides.

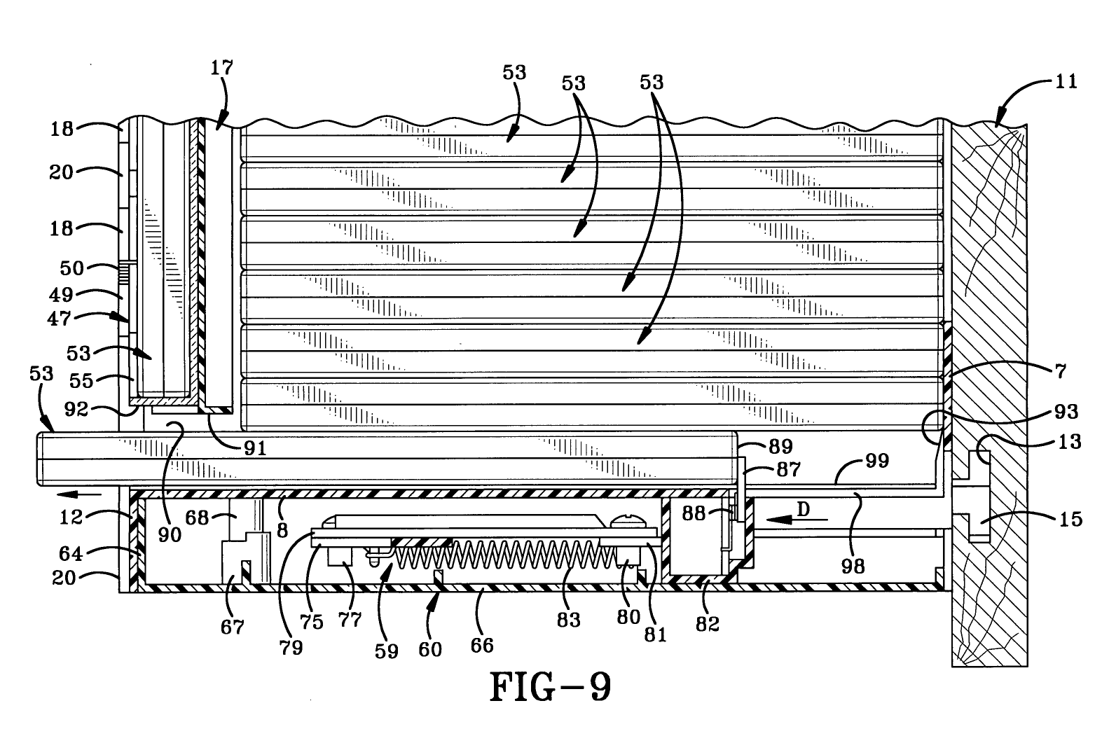

In accordance with another feature of the invention, a slide actuation mechanism indicated generally at 59 (FIGS. 3, 4, 5 and 7) is mounted within a support tray indicated generally at 60. This slide mechanism provides the means of ejecting the recorded media one at a time from a plurality of such media vertically stacked within storage compartment 10 of housing 3 as shown in FIGS. 6 and 22. Slide tray 60 has a rectangular configuration complementary in outer perimeter and dimensions to that of housing 3 and includes spaced side walls 63, front wall 64 and rear wall 65, together with a bottom wall 66. A plurality of attachment posts 67 extend upwardly from bottom wall 66 and align with similar posts 68 (FIGS. 9-11) which extend downwardly from bottom wall 8 of housing 3 for receiving fasteners (not shown) therebetween for securing support tray 60 to the bottom of housing 3.

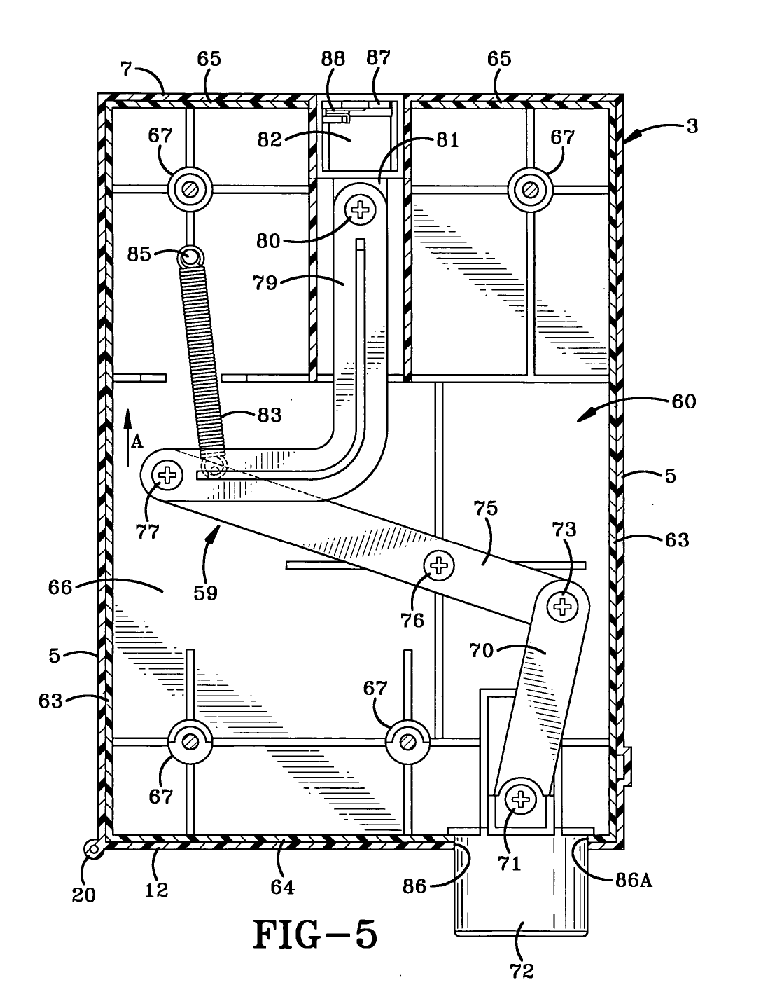

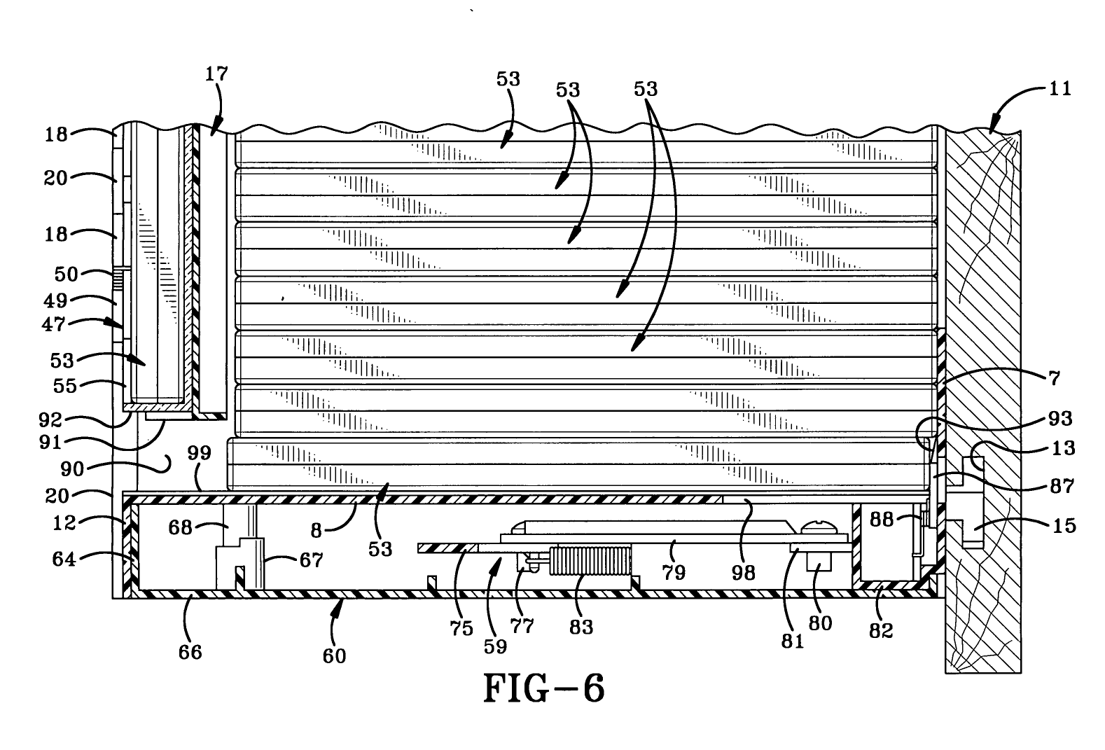

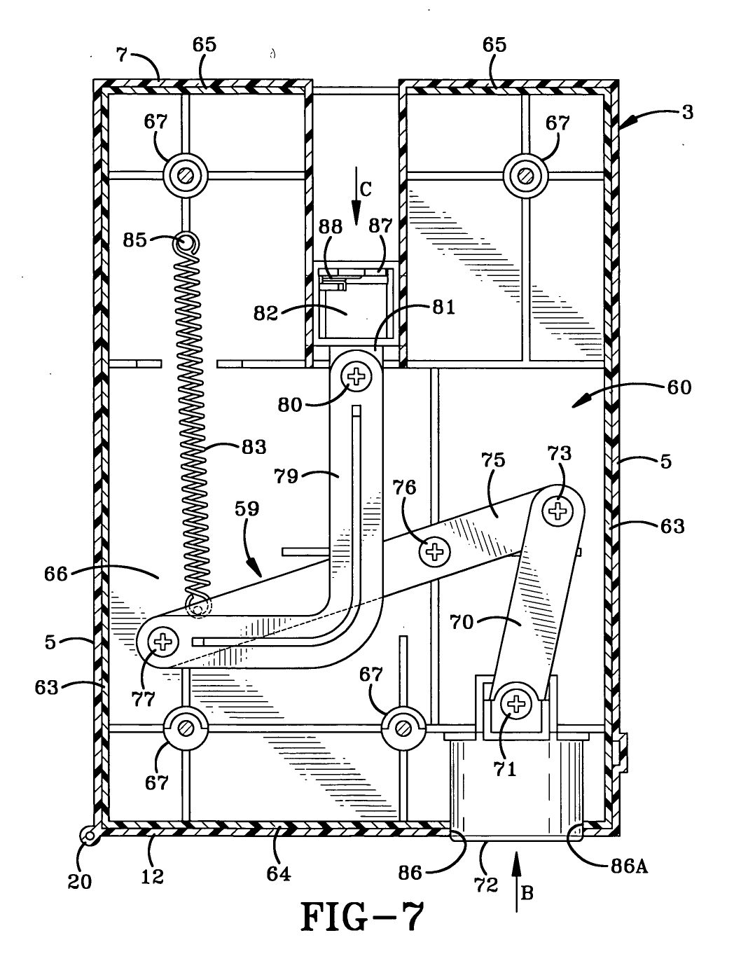

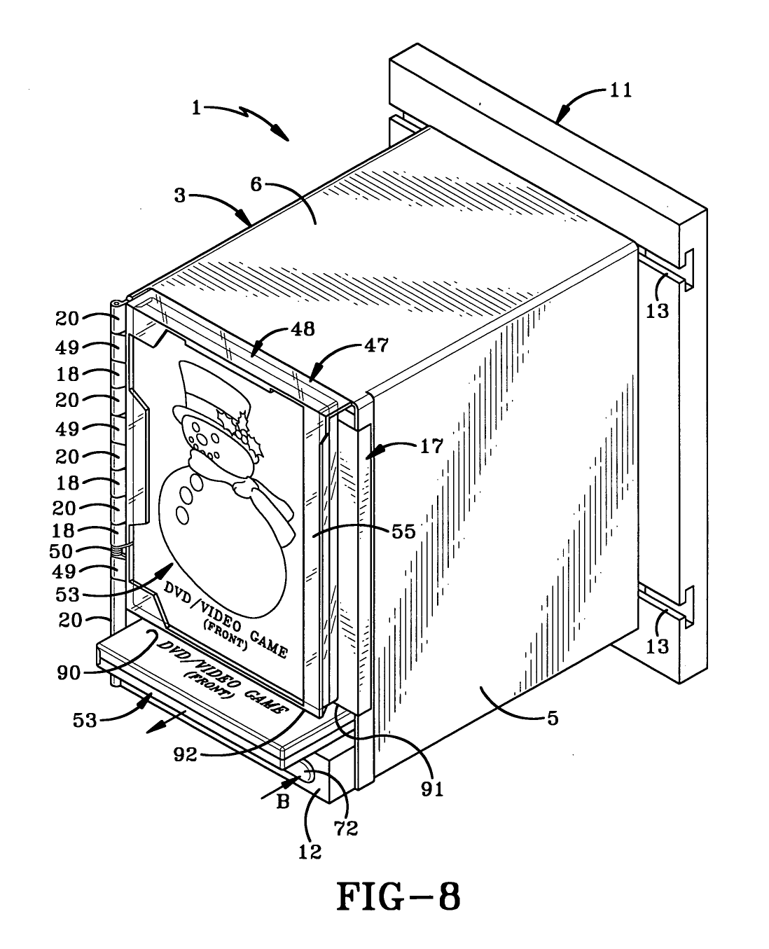

Slide mechanism 59 includes a linkage system consisting of a first link 70 which is pivotally connected by a fastener 71 to an ejection button 72. The other end of link 70 is connected by a pivot pin 73 to one end of a pivotally mounted link 75, which is secured to bottom wall 66 of tray 60 by a pivot pin 76. The other end of link 75 is pivotally connected by a pivot pin 77 to a generally curved L-shaped link 79. The other end of link 79 is connected by a pin 80 to a tab 81 extending outwardly from a rectangular-shaped slide box 82. A coil spring 83 extends between one end of L-shaped link 79 and a fixed pivot post 85 and biases the outer end of links 79 and 75 connected by pivot pin 77 in a rearward direction as shown by Arrow A in FIG. 5, which in turn biases ejection button 72 in an outward position as shown in FIGS. 4 and 5 for access by a potential customer. Button 72 extends through a complimentary shaped opening 86 formed in lower front wall portion 12 of housing 3 and through aligned opening 86A formed in front wall 64 of tray 60. Thus, FIG. 4 shows the position of the slide mechanism including the various linkages thereof, together with ejection button 72, when in an at rest position for subsequent actuation by a potential customer to discharge a recorded media from within security housing 3.

A spring loaded push tab 87 is pivotally mounted in slide box 82 and biased toward a raised position as shown in FIGS. 4 and 9 by a coil spring 88. Tab 87 engages a rear end 89 of the lowermost recorded media 53 for ejecting it partially through a front discharge opening 90 located between bottom wall 8 and a lower edge 91 of security door 17 and a lower edge 92 of display panel 47. A pair of downwardly outwardly angled ramp surface 93 (FIGS. 3 and 10-11) are formed on back wall 7 of housing 3 for moving the bottommost recorded media package 53A slightly outwardly from rear housing wall 7 as shown in FIG. 11 providing a space 95 beneath ramp surface 93 for receiving spring loaded tab 87 therein when in the at rest ready to eject position as shown in FIG. 11. Security door 17 and display panel 47 are shorter in height than that of front wall opening 9 in order to form front discharge opening 90 at the lower end of the doors. The top edge of security door 17 also is located beneath top wall 6 of housing 3 a sufficient distance to form an access opening 97 at the upper end of the door as shown in FIGS. 23 and 24 for inserting a security package 53 into compartment 10 even when security door 17 is in a closed locked position. This enables a customer to return a recorded media back into storage compartment 10 after having ejected it therefrom through front discharge opening 90, should he/she decide not to purchase the recorded media. The customer merely pivots display panel 47 to an open position as shown in FIGS. 2 and 24 and slides the recorded media through access opening 97 where it assumes the uppermost position of the stacked recorded media 53 located therein.

A customer desiring to possibly purchase one of the recorded media contained within housing 3 will usually inspect the recorded media by reviewing the front and rear panels thereof through transparent display panel 47 by moving it from the closed position of FIG. 1 to the open position of FIG. 2 where the back panel can be reviewed. The customer then pushes button 72 inwardly in the direction of Arrow B as shown in FIG. 7, which will cause the linkage mechanism to move slide box 82 fowardly in the direction of Arrow C from its at rest position of FIG. 5 to the eject position in FIG. 7. This will cause tab 87 to push the lowermost recorded media package 53 forwardly in the direction of Arrow D (FIG. 9) ejecting it partially through front discharge opening 90. A customer can then grasp a forward end of the recorded media and slide it entirely out of the storage compartment past security door 17. Immediately upon release of push button 72, coil spring 83, which was stretched from its at rest position as shown in FIG. 5 to its extended position as shown in FIG. 7, will automatically return slide box 82 and the associated linkage from the actuated extended position of FIG. 7 back to the at rest position of FIG. 5. Push tab 87 extends through an opening 98 formed in housing bottom wall until reaching its forwardmost position as shown in FIGS. 9 and 10. A pair of raised ribs 99 extend upwardly from bottom wall 8 on which recorded media 53 slides when being ejected by slide mechanism 59.

After a recorded media has been removed from the housing by a customer, the next lowermost recorded media (FIG. 10) will press downwardly on the top of spring loaded tab 87, which due to the angled top surface thereof will cause tab 87 to pivot downwardly as shown in FIG. 10, until it reaches its fully retracted at rest position as shown in FIG. 11 where it will be pivoted upwardly by the action of spring 88 into space 95 located beneath ramp surface 93. This will place it in position behind the rear edge of the now lowermost recorded media as shown in FIG. 11, for subsequent ejection the next time actuation button 72 is depressed. As shown in FIG. 11, the lowermost recorded media is pushed slightly forward by ramp surfaces 93 a sufficient distance to permit push tab 87 to pivot upwardly behind the lowermost recorded media. Thus, a customer can individually dispense as many individual recorded medias 53 he/she desires to purchase. However, the dispense mechanism prevents the rapid removal of a plurality of the recorded media from within storage compartment 10, thus reducing the susceptibility of a shoplifter removing the entire contents from housing 3 and running from the store.

A sound producing mechanism, such as a flexible plastic clip or clips 100 may incorporated into housing 3 adjacent the removal path of the lowermost recorded media package 53 from discharge opening 90. This will alert a clerk if a large number of the recorded media is removed in rapid succession since normally only one recorded media will be removed from the housing by a potential customer, thus retarding theft. The flexible plastic tabs 100 is merely just one manner in which a noise-producing device can be incorporated into housing 3 to produce the desired sound effect upon removal of a recorded media therefrom.

To unlock security door 7, a special magnetic key 101 preferably is provided having a one or more positioning tabs 102 (FIG. 17) extending outwardly therefrom which are adapted to be placed within positioning holes 23 formed in security door 17. This ensures that a pair of specially positioned magnets 103 located within key 101 are aligned with respective ones of the metal tines 43 of locking member 41 as shown in FIG. 19A. This will automatically move locking tangs 43 from their locked position of FIG. 19 where they are engaged with projections 39 formed on locked projection 47 inwardly to the unlocked position of FIG. 19A. This enables slide plate 29 to move from the locked position of FIG. 18 and 19 to the unlocked position of FIG. 19A and 20 which will disengage locking teeth 33 on lock plate 29 from locking fingers 35 of housing 3. Upon reaching the unlocked position as shown in FIG. 20, security door can be pivoted to the open position of FIG. 22 providing full access to front opening 9 of housing 3 for loading a plurality of recorded media into storage compartment 10.

Thus, a clerk merely inserts magnetic key 101 into engagement with positioning holes 23 and by sliding it downwardly a very short distance will unlock security door 17. Button 27, which extends through opening 29 will limit the amount of travel of slide lock plate 29 a sufficient distance so that locking fingers 33 and 25 move to the unlocked position enabling security door 17 to be pivoted outwardly to the open position. Upward movement of button 27 when door 17 is closed will lock fingers 33 with fingers 35 to secure door 17 in the locked position. This automatically results in metal tines 43 snapfitting into locking engagement with projections 39 as shown in FIG. 19.

In summary, dispensing device 1 enables a plurality of vertically stacked generally flat parallelpiped shaped recorded media 53 to be secured within a protected housing 3 which is supported on one or different types of supporting structures 11 enabling a customer to easily discharge a single recorded media from the secured housing by merely pressing inwardly on an exposed button 72. This automatically moves the lowermost recorded media forwardly a sufficient distance through a lower discharge opening 90 for subsequent grasping and complete removal of the recorded media from the housing by the customer. Simultaneously with this removal of the recorded media, a sound will be produced as an additional security measure. Also, the pivotally mounted front display panel enables both the front and rear of the recorded media, one of which is stored within the panel, to be reviewed easily by a perspective customer. The secured housing 3 also enables a customer to replace a previously-ejected recorded media back into the storage compartment should he/she decide not to purchase the same through top opening 97, which is easily exposed by pivoting display panel 47 to an open position while the security door 17 remains in a secured locked position. Opening 97 is sized as shown in FIG. 24, to prevent the removal of any stored contents from storage compartment 10.

It is also readily understood that other types of key actuated mechanisms could be provided for security door 17, such as a key actuated mechanical tumbler or other device, without affecting the concept of the invention. Also, the location of the link slide mechanism contained within storage tray 60 is completely secured beneath the bottom wall of housing 3 by screws or other types of fasteners. Also, the plurality of mutually engaged locking fingers 33 formed on slide plate 29 with locking fingers 35 formed on housing 3 provide an extremely strong locking engagement between security door 17 and housing 3 making it extremely difficult to forcibly open security door 17 by a potential shoplifter. The various components such as housing 3, security door 17 and slide mechanism tray 60 preferably are formed of a rigid plastic material, but could be formed of metal or other materials if desired. However, the plastic provides an extremely strong, durable and esthetically pleasing structure for mounting in a retail establishment.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A dispensing system for individually dispensing one of a plurality of stacked items of merchandise comprising:
a housing adapted to be mounted on a support structure, said housing having an internal storage compartment for storing the plurality of items in a stacked relationship;
a lockable security door mounted on the housing enabling a plurality of the items to be placed in the storage compartment when the door is in an open position;
a slide mechanism mounted adjacent a lower portion of the housing for moving one of the stacked items from the storage compartment through a discharge opening for subsequent removal by a customer when the security door is in a closed locked position; and
a display panel mounted on the housing for displaying one of the items of merchandise adapted to be dispensed from the housing.

2. The dispensing apparatus defined in claim 1 wherein an access opening is formed in the housing permitting at least one of the items to be placed in the storage compartment when the security door is in the closed locked position.

3. The dispensing apparatus defined in claim 1 wherein the display panel is pivotally mounted on the housing and is adapted to contain one of the items of merchandise between a pair of spaced transparent walls.

4. The dispensing apparatus defined in claim 1 wherein the display panel is pivotally mounted on the housing and is spring biased into juxtaposition with the security door.

5. The dispensing apparatus defined in claim 1 wherein the slide mechanism includes a tab engageable with a lowermost item of the stacked items and an actuation mechanism for moving the tab forward in the housing to move said lowermost item through the discharge opening.

6. The dispensing apparatus defined in claim 5 wherein the actuation mechanism includes a push button projecting from the housing and a link assembly operationally connecting the push button with the tab for moving the tab forward within the storage compartment when the push button is actuated by a customer.

7. The dispensing apparatus defined in claim 6 wherein the link assembly includes a first link connected between the push button and one end of a pivotally mounted second link; and a third link connected between another end of the second link and the tab.

8. The dispensing apparatus defined in claim 6 including a spring operationally connected to the link assembly for biasing the tab rearwardly in the storage compartment and biasing the push button outwardly from the housing.

9. The dispensing apparatus defined in claim 5 wherein the tab is pivotally mounted and is spring biased toward an extended position for engagement with a rear portion of the lowermost item for moving said lowermost item forwardly in the storage chamber.

10. The dispensing apparatus defined in claim 5 wherein the slide mechanism is mounted in a tray secured to a bottom wall of the housing; and in which the tab extends upwardly through an opening formed in said bottom wall.

11. The dispensing apparatus defined in claim 5 wherein a ramp surface extends inwardly into the storage compartment from a back wall of the housing for spacing the lowermost item from said back wall and forming a space for receiving the tab therein.

12. The dispensing apparatus defined in claim 1 wherein the security door is pivotally mounted on the housing and extends across on open front of the housing when in the closed locked position; in which the security door includes a lock plate slidably movable between locked and unlocked positions; and in which a plurality of locking fingers are provided on the lock plate and are movable between locking and unlocking engagement with complementary locking fingers formed on the housing.

13. The dispensing apparatus defined in claim 12 including a magnetically attractable lock mechanism for securing the lock plate in the locked position.

14. The dispensing apparatus defined in claim 13 wherein the lock mechanism includes a pair of metal tines spring biased toward locking engagement with a pair of projections provided on the lock plate.

15. The dispensing apparatus defined in claim 13 wherein the locking mechanism includes a slide button extending outwardly from the lock plate through an opening formed in the security door; and in which a pair of key positioning openings are formed in the security door for aligning a magnetic key with the lock mechanism for releasing the lock mechanism from the locked position to an unlocked position.

16. The dispensing apparatus defined in claim 1 wherein the items of merchandise are recorded media having a parallelpiped configuration.

17. The dispensing apparatus defined in claim 1 wherein the housing has an open front providing access to the storage compartment when the security door is in the open position; in which the security door when in a closed locked position forms an upper opening for placing items of merchandise into the storage chamber and forms the lower discharge opening.

18. The dispensing apparatus defined in claim 1 including a noise producing device mounted within the housing and operated upon removal of an item through the discharge opening.

19. A dispensing system for individually dispensing one of a plurality of recorded media from a plurality of the media arranged in a vertically stacked relationship, said system comprising:
a housing having a storage compartment for receiving the stacked media therein;
a security door pivotally mounted at an open front of the housing and movable between an open position and a closed locked position;
a slide mechanism engaged with a lowermost recorded media of said vertically stacked media, said mechanism including a control button extending from the housing for actuating the slide mechanism to push said lowermost recorded media out of the housing through a lower discharge opening;
a lock mechanism for unlocking and locking the security door; and
a display panel pivotally mounted on the housing and covering the security door when said display panel is in a closed position across the front of the housing.

20. A dispensing system for individually dispensing one of a plurality of recorded media from a plurality of the media arranged in a vertically stacked relationship, said system comprising:
a housing having a storage compartment for receiving the stacked media therein;
a security door pivotally mounted at an open front of the housing and movable between an open position and a closed locked position;
a slide mechanism engaged with a lowermost recorded media of said vertically stacked media, said mechanism including a control button extending from the housing for actuating the slide mechanism to push said lowermost recorded media out of the housing through a lower discharge opening;
a magnetically actuated lock mechanism for unlocking and locking the security door, said lock mechanism including a slide plate having a plurality of locking fingers engageable with complementary locking fingers formed along one side of the open front of the housing; and
a media display opening formed adjacent a lower portion of the housing and a media access opening formed adjacent an upper portion of the housing when the security door is in the closed locked position.
